(19) United States
(12) Patent Application Publication
(10) Pub. No.: US 2026/0339497 A1
(43) Pub. Date: Oct. 29, 2026

(54) System and Method for AI-Based Narrative Arc Selection and Presentation Impact Timeline Prediction

(71) Applicant: Kate Elspeth Steinmeyer, East Palo Alto, CA (US)

(72) Inventor: Kate Elspeth Steinmeyer, East Palo Alto, CA (US)

(21) Appl. No.: 19/186,617

(22) Filed: Apr. 23, 2025

(51) Int. Cl. G06F 3/04847; G06F 3/0482

(52) U.S. Cl. CPC G06F 3/04847; G06F 3/0482

(57) ABSTRACT

A system enabling presenters and content creators to select predefined or custom narrative structures optimized for audience engagement. Using artificial intelligence, the system dynamically generates a Presentation Impact Timeline that identifies predicted high-engagement points across the presentation duration. It visually highlights impactful slides, video segments, and interactive demonstration segments, and provides real-time content refinement recommendations. The system also includes automatic visual theming based on emotional tone and optionally integrates post-presentation feedback to improve future AI-generated timelines and recommendations. This allows users to enhance emotional resonance, persuasiveness, and storytelling effectiveness while maintaining alignment with user-defined time constraints and delivery preferences.

### FIELD OF INVENTION:

The invention pertains to automated presentation creation tools with an emphasis on narrative-driven audience engagement, specifically utilizing Presentation Impact Timeline to optimize slide content and interactive demonstrations.

As used herein, a “Presentation Impact Timeline” (PIT) is a timeline—generated by one or more AI models or rule-based heuristics—that maps predicted audience engagement and emotional impact across a presentation.

As used herein, an “impactful slide” is a slide within the Presentation Impact Timeline that the system predicts will achieve an audience-engagement score above a predefined threshold, the score being calculated by AI or rule-based heuristics using factors such as narrative position, content type, and historical performance.

In certain embodiments, the instructions described in this disclosure may be stored on any non-transitory computer-readable medium, including flash memory, magnetic or optical disks, and RAM; when executed by one or more processors, such instructions cause the processors to perform the methods disclosed herein.

### BACKGROUND

Presentations frequently fail to maximize audience engagement due to ineffective narrative structures and the lack of tools that help identify and emphasize emotionally impactful moments. Existing solutions do not provide visual storytelling guidance or real-time refinement based on predicted psychological engagement. This invention introduces a system that dynamically aligns emotional tone progression with classic narrative arcs and visually maps expected audience response across a presentation timeline. Unlike prior tools, this system enables presenters to predict, visualize, and optimize emotional engagement using an Presentation Impact Timeline, offering an interactive interface for refining key slides and demonstration segments based on predicted audience impact. While storytelling arcs such as the “Hero's Journey” or “Problem-Solution” have been traditionally used in public speaking and content strategy, these frameworks are applied manually and lack data-driven personalization or predictive feedback. Unlike prior solutions which statically apply narrative templates, this system dynamically adapts the arc based on emotional tone preferences, presentation duration, speaker pace, and feedback-driven refinements. The present invention goes beyond conventional storytelling structures by dynamically selecting or recommending narrative arcs, predicting audience engagement across a presentation timeline, and refining content structure using AI-generated emotional pacing and tone alignment.

This invention introduces a unique AI-enhanced system that:

Enables presenters and content creators to select predefined narrative arcs or create custom ones optimized for maximum emotional and persuasive impact.

Generates an Presentation Impact Timeline, clearly visualizing the timeline of the presentation and highlighting key slides and demonstration segments.

Provides real-time insights into predicted audience engagement for each slide, enabling interactive refinement via AI suggestions.

Offers integration with predefined user parameters such as presentation length, speaking pace, and presentation type (e.g., standard, demonstration-focused).

Integrates post-presentation feedback to inform future arc selection, slide layout templating, and visual theming via a feedback-informed template engine.

Unlike prior solutions which statically apply narrative templates, this system dynamically adapts the arc based on emotional tone preferences, speaking pace, presentation length, and ongoing refinement using audience feedback.

The invention does not claim the underlying architecture of AI models, the algorithms used for speaker note generation, or conventional presentation-building platforms that do not utilize narrative arc-based engagement timelines. The novelty lies in the integration of narrative arc-driven impact mapping, emotional tone inference, feedback-informed theme selection, and real-time adaptive content sequencing tailored to audience and pacing inputs.

For example, a sales executive creating a 10-minute product pitch may select a “Problem-Solution” arc and fast speaker pace. The system generates a dense timeline with high-impact slides early in the presentation to address urgency and deliver resolution before Q&A.

The narrative arc is a structural model guiding content flow; the Presentation Impact Timeline is a visual output reflecting that structure along a defined presentation time span.

The embodiments described herein represent the best mode known to the inventor for carrying out the invention as of the filing date.

### BRIEF DESCRIPTION OF THE DRAWINGS

The embodiments are described in detail in the following description with reference to the accompanying figures. The figures illustrate examples of the embodiments and are intended to complement, not limit, the scope of the invention.

FIG. 1 illustrates a system flow diagram showing the primary AI-based logic pathway for generating and refining presentation content, including user input, narrative arc selection, and AI-assisted slide generation.

FIG. 1A illustrates the fallback logic flow, which is triggered when the AI engine is unavailable. It shows how the system generates a rule-based Presentation Impact Timeline using storytelling heuristics, along with manual slide editing, update, and navigation options.

FIG. 1B illustrates the custom storytelling arc creation flow, where the user defines personalized tone and narrative inputs, and the system generates a tailored structure using AI.

FIG. 2 illustrates the backend system architecture responsible for processing user inputs and generating presentation structure, slide content, and fallback alternatives.

FIG. 3 illustrates a user interface for selecting a predefined or custom storytelling arc, including tone labels and visual arc representations.

FIG. 4 illustrates a timeline-based interface for previewing slide and video flow, narrative pacing, and placing impactful or demo segments across the presentation.

FIG. 5 illustrates the interface for refining individual slides based on predicted emotional engagement, including AI suggestions and manual controls.

FIG. 6 illustrates an interface for customizing key presentation parameters including speaker pace, duration, format, and storytelling arc.

FIG. 7 illustrates a modal interface that enables users to change their existing storytelling arc by selecting a new predefined option or creating a custom arc using visual previews, emotional tone labels, and AI-generated guidance.

FIG. 8 illustrates a system-level architecture diagram showing how presentation content is generated through AI-based narrative arc selection, emotional engagement prediction, and a feedback-informed refinement loop. The diagram highlights the interactions between the user device, backend AI modules, template engine, and feedback mechanisms.

### DETAILED DESCRIPTION

In one preferred embodiment of the invention, the system operates through a browser-based or native application interface, allowing users to select a narrative arc, preview a timeline of predicted engagement, and refine slides using AI-generated suggestions.

As used herein, ‘emotional engagement’ refers to predicted psychological states of the audience—such as attention, interest, curiosity, or excitement—estimated through heuristic or AI-based scoring models aligned with narrative pacing.

### Narrative Arc Selection:

Users choose from predefined narrative structures (e.g., Hero's Journey, Persuasive Framework).

### Presentation Impact Timeline:

Visual timeline depicting audience engagement predictions. Distinct visual identification of impactful slides and interactive demonstrations.

### Slide, Video and Demo Segment Impact Highlighting:

As used herein, a “video segment” refers to a pre-recorded media block included in the presentation timeline. These segments may include marketing videos, instructional content, or speaker introductions. They differ from slides or demo segments in that they are fixed-duration and typically not generated or editable by the system. Video segments contribute to the overall pacing and narrative arc structure.

AI identifies and visually emphasizes slides and demonstration segments with the highest predicted emotional and psychological engagement.

### Interactive Slide Refinement:

Detailed AI recommendations for improving slides or demo segments based on predicted emotional payoff. User-driven decision-making with options to refine, accept, or defer suggestions.

### Integration of User Preferences:

Incorporates presentation duration, speaker pace, and presentation format to ensure personalized and optimal outcomes.

While the system accepts presentation duration, speaker pace, and note preferences as input parameters, this invention does not claim the logic of slide pacing or speaker note generation, which may be addressed in complementary systems.

### Fallback Behavior for Presentation Impact Timeline:

The fallback logic may be triggered by system-defined thresholds such as timeout errors, AI model unavailability, or null output from the AI generation engine. In this mode, slide impact is estimated using predefined heuristics derived from the selected narrative arc, presentation length, and pacing. For example, key narrative beats (e.g., climax, tension, resolution) are mapped to predefined slide positions based on standard storytelling timelines (e.g., the midpoint or final third of the presentation). Placeholder visuals and text indicate predicted impactful moments, allowing the user to proceed with narrative planning even in the absence of AI-generated engagement predictions. Visuals may include sample headings, slide structures, or pre-labeled emotional markers (e.g., ‘Climax Slide’, ‘Contrast Moment’) based on heuristic placement rules.

The system optionally incorporates post-presentation feedback to enhance future AI performance. Feedback can include presenter evaluations, audience interaction data, time spent per slide, skipped segments, or user-provided ratings. This data is aggregated (e.g., anonymized and batched) and used to retrain or fine-tune the AI models that power narrative arc recommendations and impactful slide detection. As a result, the system continuously adapts its engagement prediction algorithms to better align with real-world presentation outcomes and individual presenter styles.

The system may adjust future template and visual theme selections based on historical performance of emotional tone combinations. For instance, if a particular emotional arc consistently yields higher engagement when paired with a specific visual style or template family, the system can learn from these outcomes and prioritize those combinations in future presentations. This adaptive visual assignment is based on aggregated feedback data and helps optimize both storytelling structure and aesthetic alignment without requiring manual configuration by the user.

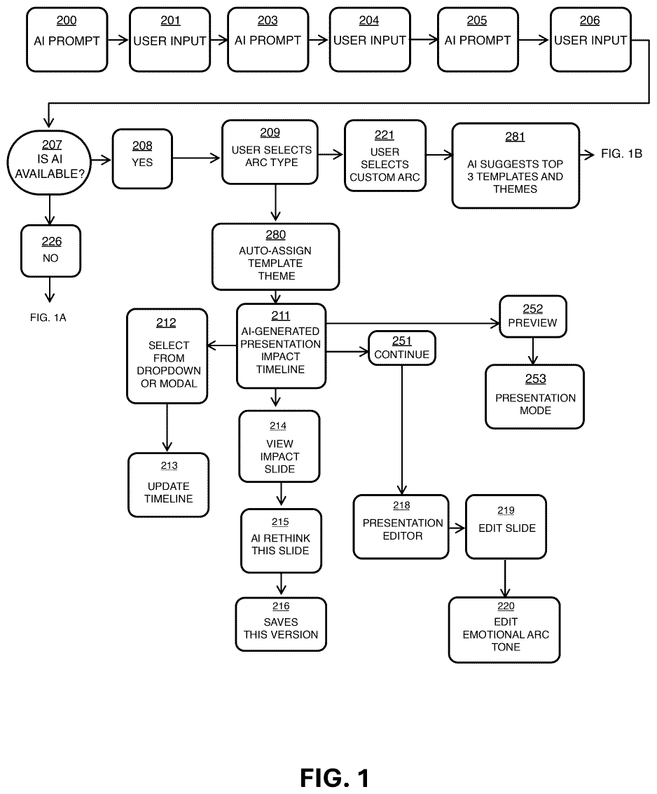

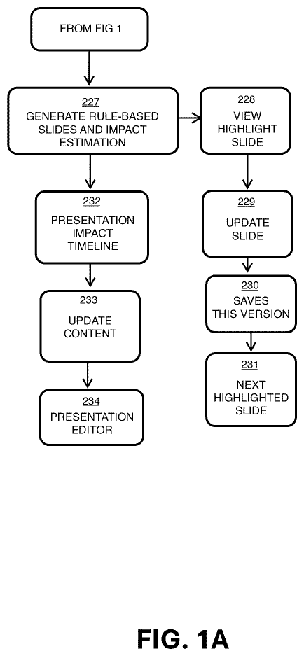

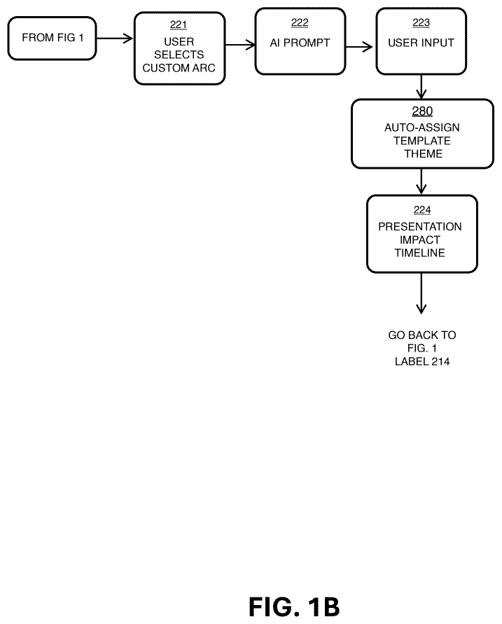

FIG. 1 illustrates the initial user flow and system logic for generating a presentation using either an AI-based engine or fallback rule-based heuristics. The process begins with a sequence of AI-generated prompts (200, 203, 204, 205), followed by corresponding user input steps (201, 206). These prompts guide the user through defining the presentation topic, selecting a type (e.g., Presentation+Demo), duration, speaker pace, note format, and a preferred storytelling arc.

At decision node (207), the system determines whether the AI generation engine is available. If not (226), the process transitions to the fallback flow shown in FIG. 1A.

If AI is available (208), the user proceeds to select a storytelling arc type (209). If the user opts for a custom arc, the process continues via step (221), initiating a custom arc configuration flow. The system may optionally perform step (281), where the AI suggests the top three relevant templates and themes. That custom flow is described in FIG. 1B.

For standard arcs, the flow proceeds directly to step (280), where the system automatically assigns a presentation template and visual theme based on the arc's emotional structure. This assignment occurs in the background, without presenting theme or template choices to the user at this stage. These defaults can be customized later in the Presentation Editor (218).

The system then generates a Presentation Impact Timeline (211), mapping predicted emotional intensity and highlighting key content moments. The user may refine presentation parameters via dropdowns or modals at step (212), which update the timeline in step (213).

At step (214), the user selects an impactful slide for detailed preview. Available actions include invoking AI to re-generate the content (215), saving the version (216), or continuing with the existing version.

The user can either proceed to the full Presentation Editor (218) via the “Continue” control (251) or enter playback mode (253) via the “Preview” button (252). Within the editor, users can finalize design choices (219) and optionally revise emotional tone settings or arc structure (220).

FIG. 1A illustrates the system behavior when the AI engine is unavailable, beginning at decision node (208) in FIG. 1. At step (227), the Fallback Logic Engine is activated. This component uses predefined rules and heuristics to construct a slide sequence and estimate key engagement moments without relying on AI generation.

At step (228), the system presents a highlight slide to the user. Interactive options include manually updating the slide's design or content (229), saving the current version (230), or skipping to the next highlight (231). The fallback presentation timeline (232) is displayed, showing an overview of the generated structure.

If the user modifies presentation settings such as type, time, or narrative arc, or manually adjusts slide content, those updates are processed at step (233). Once all slides are finalized or skipped, the user is transitioned to the Presentation Editor (234) to continue with manual or visual refinements.

FIG. 1B illustrates a flow for generating a presentation using a custom storytelling arc, which is initiated when the user selects the “Custom Arc” option in FIG. 1. At step (221), the system prompts the user to define a personalized storytelling arc by specifying emotional tones, narrative beats, or messaging goals.

An AI prompt (222) is presented to guide the user through the customization process, followed by structured input at step (223), such as tone sequences (e.g., “Concern→Curiosity→Confidence”), message categories, or narrative inflection points.

Immediately afterward, the system proceeds to step (280), where a visual template and design theme are automatically assigned based on the emotional structure of the custom arc. This assignment occurs in the background without user intervention.

The AI then generates a Presentation Impact Timeline (224), visualizing predicted emotional pacing and key engagement points. From this stage, the workflow returns to FIG. 1 at step (214), where the user may view and refine slides flagged as impactful.

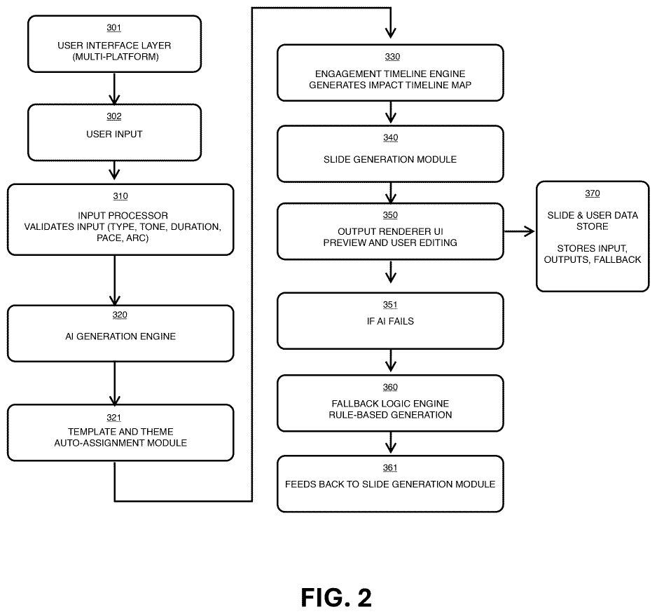

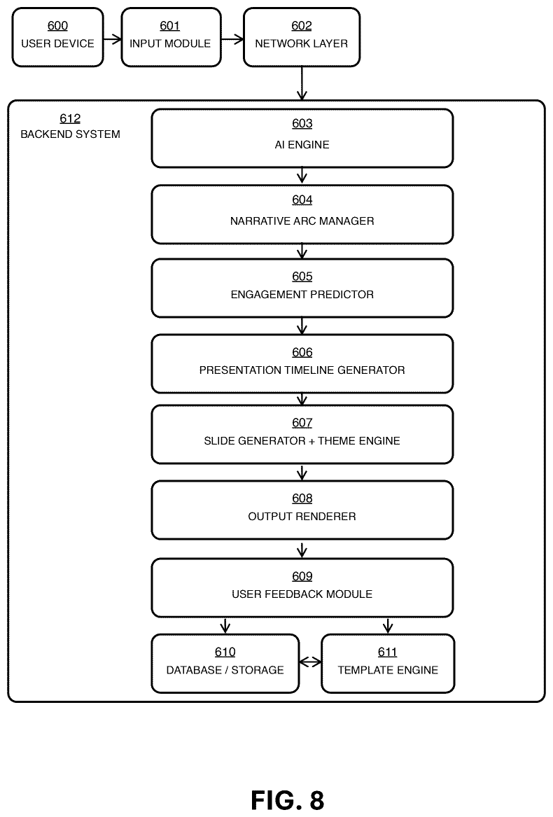

FIG. 2 illustrates a functional processing flow of the system backend responsible for generating a presentation's narrative impact timeline, slide content, and fallback behavior in the event of AI unavailability. This figure emphasizes sequential logic and system decisions rather than modular system architecture (as shown in FIG. 8).

This system may operate across various environments, including web, mobile, desktop, TV, and virtual or augmented reality platforms, with input responsiveness tailored to each device's capabilities.

The flow begins with a User Interface Layer (301), where users input presentation details such as type, emotional tone, duration, speaker pace, and narrative arc. These inputs are passed to the Input Processor (310), which validates and structures them, resolves conflicts, and extracts key configuration data for downstream use.

Validated input is then sent to the AI Generation Engine (320), which uses generative AI models to create slide content and speaker notes aligned with the selected arc and pacing.

Before slide generation begins, the Template and Theme Auto-Assignment Module (321) automatically assigns a visual theme and slide template based on the selected emotional tone, pacing, and arc structure. This assignment occurs in the background without requiring user input at this stage, allowing consistent visual styling throughout the generated presentation.

If AI generation is successful, the output is forwarded to the Engagement Timeline Engine (330), which predicts emotional pacing and identifies high-impact narrative points. This engine constructs a psychological engagement map across the presentation duration, mapping the anticipated emotional trajectory aligned with the arc.

The Slide Generation Module (340) then compiles modular slides based on the engagement timeline and generated content. Each slide includes metadata such as narrative position, emotional scoring, and timing alignment. Demo segments, transitions, and speaker notes may be embedded here as well.

The Output Renderer UI (350) transforms the slides into previewable or editable formats for the user. If the AI Generation Engine (320) fails or inputs are incomplete, the system triggers the Fallback Logic Engine (360), which assembles slides using predefined heuristics and static templates without relying on generative AI.

All generated or modified presentation data is stored in the Slide and User Data Store (370), which preserves AI-generated content, fallback versions, and user edits for recovery, iteration, or export.

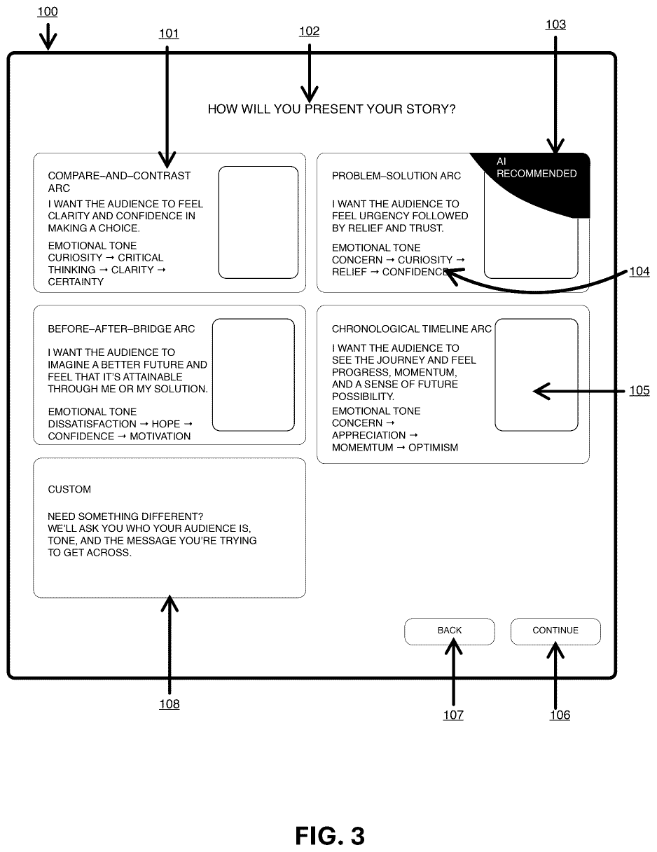

FIG. 3 illustrates a user interface (100) that allows the user to select a predefined or custom storytelling arc during the presentation setup process. This interface is typically presented early in the configuration flow and is designed to operate across various environments, including web, mobile, desktop, TV, and virtual or augmented reality platforms. Input responsiveness is tailored to the capabilities of each device type.

The main interface is structured within a central card container (101), which groups the arc selection controls and supporting information. At the top of the card, a narrative-focused prompt (102) is displayed, such as “How will you present your story?” This prompt encourages the user to consider the audience experience and the structure of the message being delivered.

Beneath the prompt, the system displays a series of arc selection tiles. Some tiles include an AI-generated recommendation label (103) that appears when the system infers an optimal arc based on the user's presentation inputs. The tiles also contain an emotional tone label (104), summarizing the general emotional progression associated with the arc (e.g., “Concern→Curiosity→Relief→Confidence”), and a visual preview (105) that represents the structure or shape of the arc, often displayed as a stylized line or curve.

Users can select an arc by clicking on one of the tiles. Once selected, the corresponding arc informs how slides will be generated and positioned along the presentation timeline—affecting which moments will carry greater narrative weight. For example, selecting a “Before-After-Bridge” arc will result in a structure that emphasizes contrast and transformation, while a “Hero's Journey” arc will create a structure with a clear turning point and emotional climax.

At the bottom of the interface, users may proceed by clicking the “Continue” button (106) or return to the previous step via the “Back” button (107). An additional tile labeled “Custom” (108) allows the user to define a unique storytelling arc. Selecting this option launches a guided flow that prompts the user to enter specific emotional tones, audience reactions, or key narrative beats. The system then uses this input to generate a custom arc structure using AI assistance.

This interface empowers users to shape their presentation using well-known storytelling frameworks, thereby improving audience resonance and emotional pacing before any content is generated.

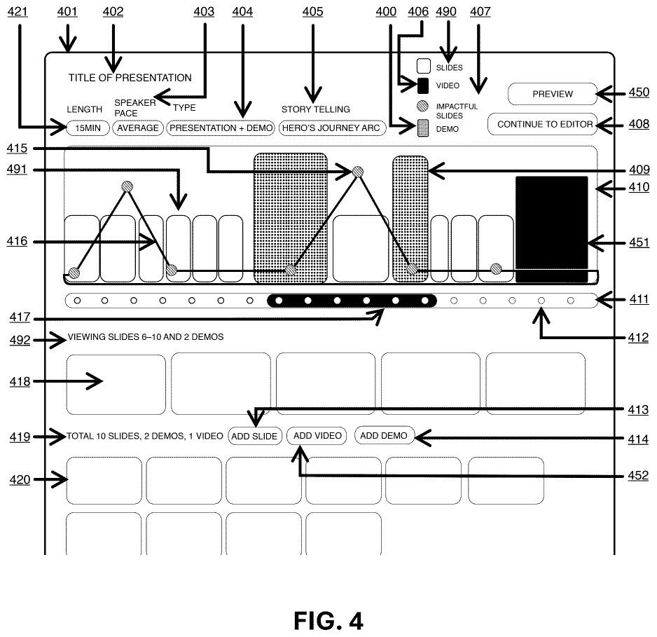

FIG. 4 illustrates an interface (401) that allows users to preview and edit a presentation using a timeline-based view that reflects the predicted emotional pacing and narrative flow.

At the very top of the interface, the title of the presentation (402) is displayed, followed by user-defined presentation parameters—speaker pace (403), presentation type (404), selected storytelling arc (405), and presentation duration (421). Directly beneath the slider, the system shows a dynamic range indicator (492) that reads, for example, “VIEWING SLIDES 6-10 AND 2 DEMOS.” This indicator updates in real time as the user pans or zooms the timeline slider, providing immediate feedback on which subset of slides, demo segments, and/or video segments is currently in view.

Next to the title and parameters, a slide legend (490) displays visual keys for every timeline element—including regular slide markers (491), video segments (400), demo segments (406), and impactful-slide markers (407). This legend enables users to interpret each symbol rendered on the timeline canvas.

The timeline includes a visible narrative arc curve (416) that runs continuously across the presentation timeline. This curve represents the predicted narrative structure of the presentation based on the selected storytelling arc. It visually outlines the intended emotional flow and story progression, indicating where key moments such as setup, rising action, climax, and resolution should occur. The arc guides slide sequencing and the placement of slides, demo segments, and video segments by helping the user plan which content elements will carry the most narrative weight. For example, selecting a “Hero's Journey” arc will generate a different structural curve than a “Problem-Solution” arc, influencing the pacing and emphasis of slide generation.

Overlaid on this narrative-arc curve (416) are visual markers for demo segments (409), video segments (452), impactful-slide points (415), and individual slide markers (491)—the latter ensuring that every slide in the deck is represented on the timeline. Each marker's position is determined by AI-generated or rule-based predictions aligned with the arc's structure. A video segment marker (451) appears in the same style as demo segment markers (409) but with a distinct legend key (400) for clarity. In addition to inspecting impactful-slide points, the user may hover over any marker to summon a micro-preview tooltip showing the element's title, predicted engagement score, emotional-tone label, and other metadata without leaving the canvas. Clicking or tapping a slide marker (491) loads that slide's full preview in the content-preview strip beneath the timeline, allowing rapid, in-context review and editing.

A timeline scrubber or horizontal slider (411) allows the user to navigate between different points in the presentation, with evenly spaced minute markers (412) providing reference for temporal alignment. When the user selects one or more segments of the timeline (417)—whether slides, demo segments, or video segments—the corresponding previews (418) are displayed below the canvas. These previews reflect the specific items selected and allow for quick inspection in narrative context. Below this area, a persistent section (420) displays all presentation content—including slides, demo segments, and video segments—in their full chronological sequence. This area reflects the ordered flow of the presentation and provides editing tools. Users can rearrange the sequence by dragging elements and delete individual items via tap or click actions, ensuring intuitive, flexible control over the final structure.

Users may add new content by selecting interface elements such as the “Add Slide” button (413), the “Add Demo” button (414), or the “Add Video” button (452), which insert new elements at the selected timeline point. Once satisfied with the configuration, users can either activate the “Preview” button (450) to view the current deck in presentation mode, or select the “Continue to Editor” button (408) to enter the full presentation editor interface.

This interface provides an intuitive, visually structured method for aligning presentation content with emotional pacing and audience engagement predictions, allowing real-time interaction and customization of the narrative timeline.

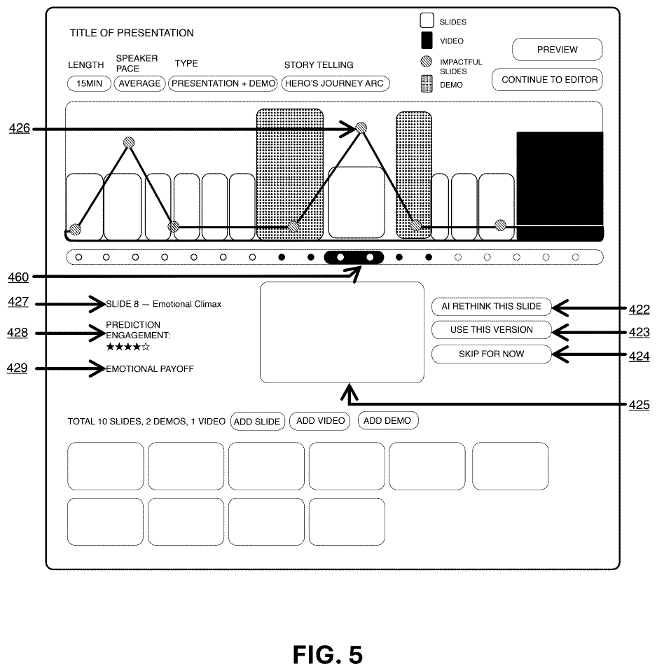

FIG. 5 illustrates an interface (425) that enables the user to view and refine a specific slide selected from the presentation's narrative impact timeline. This interface is typically invoked when the user clicks or taps on a visual marker (426) within the timeline canvas described in FIG. 4.

Once triggered, the highlighted slide preview (425) presents key information to assist the user in making refinement decisions. This includes the slide's sequence number and emotional tone label (427), a predicted engagement score (428) represented through a visual indicator such as a star or bar-based metric, and a brief description (429) outlining the intended emotional or communicative effect of the slide.

A visual timeline is displayed at the top of the interface, showing the full presentation duration segmented by content elements. When a slide, demo, or video segment is selected, its corresponding section is highlighted (460) to indicate how much time it occupies within the overall presentation. This visual cue helps users understand the temporal footprint of the selected element—e.g., two minutes—by showing a proportionally larger or smaller segment in the timeline.

Users are provided with multiple interactive options for refining or proceeding with the current slide. A selectable control labeled “AI Rethink This Slide” (422) allows the user to invoke the AI engine to regenerate the slide's design and copy while preserving its narrative intent. If the user is satisfied with the current version, they may confirm it using the corresponding control (423). Alternatively, they may choose to skip the current highlight and continue with the presentation workflow using another control (424).

This interface supports granular content refinement by providing both AI-assisted and manual options, framed within the context of predicted audience engagement. It forms a core part of the feedback loop that empowers the user to align slide-level content with the broader narrative arc, emotional pacing strategy, and time constraints.

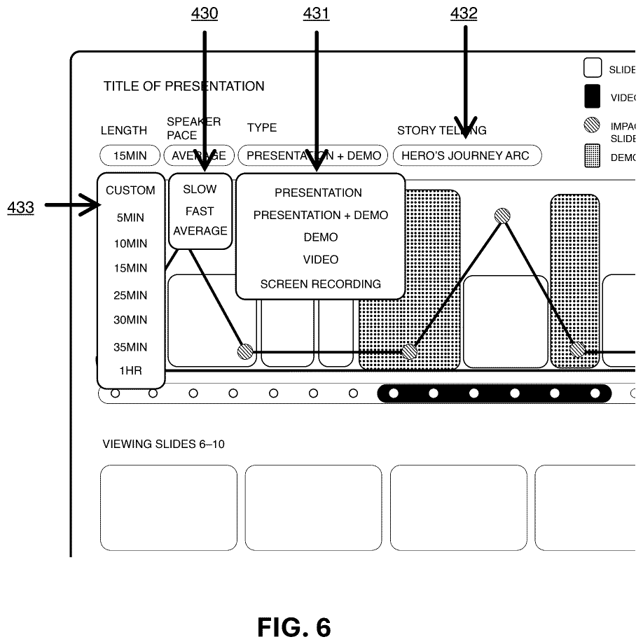

FIG. 6 illustrates a user interface that enables presenters and content creators to customize key presentation parameters including pacing, duration, format, and narrative arc. These settings directly influence how the system generates and refines slide content, emotional pacing, and the overall structure of the presentation.

At the top of the interface, users can select a desired speaker pace using a dropdown menu (430), with options such as “Slow,” “Average,” or “Fast.” This setting affects the density of content, timing per slide, and pacing distribution across the generated presentation.

The presentation type dropdown menu (431) allows users to choose from available formats such as “Presentation,” “Demo,” “Video,” “Screen Recording,” or hybrid formats such as “Presentation +Demo” or “Presentation +Video.” The selected format informs the slide layout, the presence and positioning of demonstration, video, or screen recording segments, and the total number of slides or media blocks to be generated. Each format may apply distinct logic for timeline segmentation and engagement prediction.

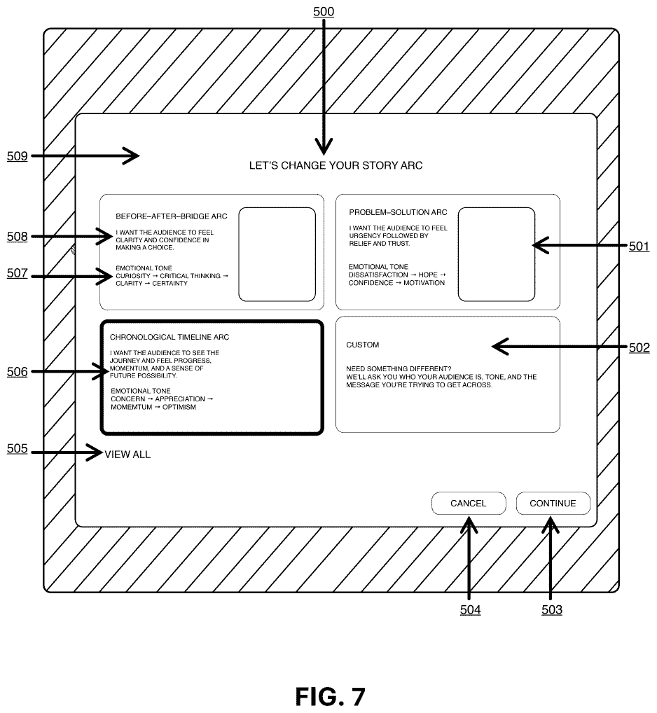

The storytelling arc selector (432) is presented as a dropdown menu or modal trigger, enabling users to choose from predefined narrative structures or initiate the creation of a custom arc. Selecting this option may launch the storytelling arc modal described in FIG. 7.

The presentation time selector (433) enables users to choose from preset durations (e.g., 5, 10, 20, or 30 minutes) or enter a custom time. This value is used by the system's generation engine to calculate pacing, slide count, and the distribution of emotional engagement moments throughout the presentation.

Together, these interface components support dynamic, real-time adjustment of presentation parameters. When changes are made, the system automatically recalculates the narrative structure, emotional pacing curve, and AI-generated slide content to reflect the updated inputs, ensuring that each presentation format remains aligned with the user's intent and delivery constraints.

FIG. 7 illustrates a modal interface (509) that enables users to select or customize a storytelling arc as part of their presentation setup. This modal may appear either during the initial configuration phase or later during editing when users wish to revise their narrative structure.

At the top of the modal, the system displays an AI-generated prompt (500), such as “Let's Change Your Story Arc,” which offers contextual guidance for the task at hand. The body of the modal contains a series of visual cards representing various storytelling arcs. Each card includes a preview image or illustration (501), a short written description (508) summarizing the arc's structure or expected audience effect, and an emotional tone label (507) that indicates the general narrative trajectory—for example, “Curiosity→Tension→Resolution.”

If the user opts to create a custom arc, they may select the “Custom Arc” option (502), which triggers a guided input flow. This flow allows the user to define tones, key moments, or narrative shapes, which the system then uses to generate a personalized arc structure through AI assistance.

The modal visually highlights the currently selected arc card (506), ensuring the user can easily distinguish their active choice. Additional arc options may be explored using the “View All” button (505), while the user can finalize their selection by clicking the “Continue” button (503), or exit the modal by selecting the “Cancel” button (504).

Upon the user's selection of a storytelling arc, the system may automatically assign a presentation template and visual theme that align with the chosen arc's emotional tone and pacing profile. These visual settings, such as color schemes, typography, and layout templates, are generated in the background and not exposed to the user during the arc selection process. Users retain the ability to review and update both the theme and template settings later during the editing stage, via the presentation editor interface.

This interface supports a dynamic, emotionally guided narrative creation process, helping users structure their presentations for maximum audience engagement using both visual previews and intelligent customization tools.

FIG. 8 illustrates a system-level architecture for generating presentation content using AI-powered narrative arc selection, engagement prediction, and a feedback-driven refinement loop.

The system consists of a user-facing interface and a backend system (612) that coordinates AI logic, prediction models, and content generation engines.

At the front end, the User Device (600) transmits data through the Input Module (601) and the Network Layer (602) to the backend infrastructure. The input may include presentation goals, audience type, selected arc, tone preferences, or custom prompt instructions.

Within the Backend System (612), the AI Engine (603) orchestrates all intelligent generation processes, acting as the central controller. The Narrative Arc Manager (604) selects or customizes a storytelling arc structure based on user preferences or AI inference. The Engagement Predictor (605) evaluates emotional pacing and expected audience resonance based on arc structure, timing, and tone. The Presentation Timeline Generator (606) constructs a timeline view showing arc-based flow, emotional impact, and key slide or demo placements.

The Slide Generator +Theme Engine (607) creates slide content and automatically applies visual theming based on narrative and tone. The Output Renderer (608) assembles final presentation files or UI views for user preview and editing. The User Feedback Module (609) captures post-presentation metrics or user-submitted feedback to inform future improvements.

The system also includes a Database/Storage (610) for storing user data, generated content, tone mappings, and performance history. A dedicated Template Engine (611) is used when selecting or adjusting visual presentation styles. This engine may be influenced by user preferences, emotional tone settings, or feedback loops.

This architecture supports both real-time generation and asynchronous refinement, enabling dynamic adjustment of presentation elements based on predicted or observed engagement.

1. A computer-implemented method for generating a presentation using AI-assisted narrative arc selection and predicted audience engagement visualization, the method comprising:
(a) receiving user input including presentation type, duration, speaker pace, selected narrative arc, and target emotional tone;
(b) generating a presentation impact timeline interface comprising visual indicators of predicted engagement, including impactful slides and interactive demonstration segments;
(c) generating slide content aligned with the selected narrative arc using an AI generation engine;
(d) analyzing the generated slide content to determine predicted emotional or psychological impact at different time intervals;
(e) providing a visual interface enabling the user to view, select, and refine individual slides based on predicted engagement; and
(f) outputting the finalized presentation, wherein finalized content reflects refined narrative pacing, emotional tone alignment, and optimized engagement markers.

2. A system for generating and optimizing presentation content using AI-based narrative arc selection, comprising:
(a) an input processor configured to receive presentation parameters including duration, speaker pace, format, narrative arc, and target emotional tone;
(b) an AI generation engine configured to generate presentation slides aligned with the selected narrative arc and presentation parameters;
(c) an engagement timeline engine configured to evaluate predicted emotional engagement across the presentation and generate a visual timeline;
(d) a user interface configured to display said timeline, including visual indicators of high-impact slides and interactive demonstration segments;
(e) a slide refinement engine configured to provide AI-assisted suggestions for improving individual slides based on predicted engagement metrics;
(f) a fallback logic module configured to generate slide content using predefined heuristics when the AI generation engine is unavailable.

3. The method of claim 1, wherein the user interface includes a timeline slider allowing navigation across different time intervals of the presentation.

4. The method of claim 1, wherein the fallback behavior activates a rule-based engine to estimate engagement levels when AI generation is unavailable.

5. The system of claim 2, wherein the user interface allows users to adjust presentation parameters and dynamically regenerate content and timelines.

6. The method of claim 1, wherein the speaker pace selection dynamically adjusts the presentation impact timeline by modifying slide density, time allocation per slide, and emotional pacing distribution, such that:
(a) a “Slow” pace generates fewer slides with longer durations per slide;
(b) an “Average” pace generates a balanced slide distribution; and
(c) a “Fast” pace generates a higher number of concise slides with condensed transitions between emotional engagement points.

7. The system of claim 2, wherein the engagement timeline engine modifies the emotional pacing and visual structure of the presentation timeline based on the selected speaker pace, presentation type, and presentation duration, such that:
(a) presentations with longer durations distribute emotional peaks across a wider timeline;
(b) faster speaker pace results in more condensed slide clusters with shorter transitions between emotional states; and
(c) presentation types such as “Demo,” “Video,” or hybrid formats allocate specific segments within the timeline for non-slide content blocks.

8. The method of claim 1, wherein the selected narrative arc determines the emotional pacing of the presentation by influencing the placement and emphasis of impactful slides, such that distinct arcs (e.g., “Problem-Solution,” “Hero's Journey”) result in different distributions of high-engagement moments along the presentation timeline.

9. The system of claim 2, wherein the user interface includes a modal interface configured to display multiple narrative arc options as visual cards, each card comprising an illustration of the arc structure, an emotional tone label, and a description of the intended audience effect, and further configured to allow the user to select or define a custom arc structure.

10. The method of claim 1, wherein the selected emotional tone dynamically influences the narrative pacing, visual theme, and slide density across the generated presentation.

11. The method of claim 1, further comprising generating a visual timeline that maps predicted emotional engagement across discrete time intervals, and visually highlights high-impact slides, demo segments, or transitions.

12. The method of claim 11, wherein users are enabled to select individual timeline segments and refine associated slide content based on the predicted engagement level at that point in the timeline.

13. The method of claim 10, wherein the system automatically assigns a presentation template and visual theme based on the selected emotional tone and narrative arc, without requiring user input at the time of assignment.

14. The system of claim 2, further comprising an emotional tone module configured to influence narrative structure, pacing, and visual theming of the presentation based on user-selected emotional tone inputs.

15. The method of claim 1, further comprising activating a fallback content generation module configured to use rule-based heuristics to estimate engagement and slide pacing when the AI generation engine is unavailable.

16. The system of claim 2, wherein the AI generation engine is further configured to personalize narrative structure and engagement pacing based on inferred audience type or presentation context.

17. The method of claim 1, further comprising collecting post-presentation feedback data, including viewer engagement or presenter annotations, and updating the AI generation engine to improve future narrative arc selection and engagement prediction.

18. The system of claim 2, wherein the user interface includes a modal or preview component configured to display a visual summary of each narrative arc, including a representative emotional tone flow and predicted audience impact, prior to selection.

19. The system of claim 2, further comprising a template engine configured to assign presentation slide layouts and visual themes based on the selected emotional tone and narrative arc, wherein such assignments are performed automatically prior to user editing.

20. The method of claim 15, wherein the system modifies future template and visual theme selections based on aggregated emotional tone effectiveness across prior presentations.

21. A computer-readable data structure embodying a Presentation Impact Timeline, the data structure generated by a presentation authoring system, comprising:
(a) a plurality of timeline entries, each timeline entry including a timecode indicating a position within a presentation duration;
(b) for each timeline entry, a predicted audience engagement score; and
(c) a content identifier referencing a slide or impactful slide, video segment, or demonstration segment associated with the timecode;
wherein the data structure is generated by an algorithm that maps a selected narrative arc, speaker pace, presentation duration, and emotional tone to predicted audience engagement scores at the respective timecodes.

22. A non-transitory computer-readable medium having stored thereon instructions that, when executed by one or more processors of a computer system, cause the computer system to perform the method of claim 1.
